(19) United States
(12) Patent Application Publication
(10) Pub. No.: US 2007/0066390 A1
(43) Pub. Date: Mar. 22, 2007

(54) Gaming machine

(75) Inventors: Masaki Matsuno, Tokyo (JP); Junpei Sato, Tokyo (JP); Hirobumi Toyoda, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP

(21) Appl. No.: 11/514,333

(22) Filed: Sep. 1, 2006

(30) Foreign Application Priority Data
Sep. 16, 2005 (JP) 2005-270855

(51) Int. Cl. A63F 13/00

(52) U.S. Cl. 463/31

(57) ABSTRACT

A gaming machine according to one embodiment of the invention is a gaming machine which provides a series of games using a plurality of player terminals (sub-player terminals) each displaying a status of a game of respective one of players, and a panel portion displaying statuses of the game of all the players, has a game controller that performs control to conduct the game, and an assignment manager that manages assignment of a right to play in the status of the game of a player playing the game, and thereby provides an occasion to participate in the game to a person who desires to participate in the game.

### BACKGROUND OF THE INVENTION

The present invention relates to a gaming machine, and more particularly, to a gaming machine in which a player bets a game value to play a game, and when wining, is able to obtain an amount of game value corresponding to the bet game value.

In recent years, gaming machines that recreate the realism of games carried out in a casino have begun to penetrate the market. For example, proposed as such gaming machines is a gaming machine which is provided with a common display device that displays an image of a dealer (dealer image) that distributes cards, and dedicated display devices each displaying an information image of a card game, displays the dealer image toward the install direction of the dedicated display devices to which the cards are distributed, and thereby makes players opposite to the dealer virtually to give the realism (for example, see JP 2004-8706, U.S. Pat. No. 5,390,934).

However, in the aforementioned gaming machine, when all the dedicated display devices are being used for the game by players, a person (hereinafter, referred to as a participation desirer as appropriate) who desires to participate in the game needs to wait for finish of the game of the currently participating player. It is considered increasing the number of participants in the game to cope with such a problem, but it becomes a factor of inhibiting recreation of the realism increasing the participants exceeding the suitable number of players participating in the game.

In particular, when the time is long elapsed before the currently participating player finishes the game, such a long time may become a cause of the participation desirer abandoning participation in the game, and there is a problem that an undesired situation occurs on the store and operation company that try to improve a characteristic of pulling in customers.

It is an object of the present invention to provide a gaming machine enabling improvements in the characteristic of pulling in customers of a game while causing the game to proceed by a number of players suitable for acquisition of a sense of realism.

### BRIEF SUMMARY OF THE INVENTION

In an aspect of the present invention, provided is a gaming machine which provides a series of games using a plurality of player terminals each displaying a status of a game of respective one of players, and a common display portion displaying statuses of the game of all the players, and which has a game controller that performs control to conduct the game, and an assignment manager that manages assignment of a right to play in the status of the game of a player playing the game.

Further, in the gaming machine of the invention, the assignment manager displays in the player terminals a screen that receives a request for assignment of the right to play in the status of the game of the player playing the game, or a screen that receives permission/rejection of assignment of the right.

Furthermore, in the gaming machine of the invention, the plurality of player terminals includes sub-player terminals operated by participation desirers who are not able to participate in the game.

Still furthermore, in the gaming machine of the invention, the assignment manager manages assignment of a right to play in part of a game included in the game.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which;

FIG. 1 is an external view of a gaming machine according to one embodiment of the invention;

FIG. 2 is an enlarged view of a player terminal constituting part of the gaming machine;

FIG. 3 is a schematic block diagram of an internal structure of the gaming machine;

FIG. 4 is a block diagram of the gaming machine mainly showing a main controller of the gaming machine;

FIG. 5 is a functional block diagram illustrating a control system of the player terminal;

FIG. 6 is a block diagram to explain a function of a microcomputer of the player terminal (sub-player terminal), while being a functional block diagram mainly related to processing of assigning a right to play;

FIG. 7 is a sequence diagram to explain processing when the right to play is assigned between the player terminal and the sub-player terminal in the gaming machine;

FIG. 8 is a view showing an example of a screen layout displayed in a front display of the game;

FIG. 9 is a view showing an example of a screen layout displayed in a liquid crystal display of the player terminal;

FIG. 10 is a view showing an example of a screen layout of an assignment request receiving screen displayed in a liquid crystal display of the sub-player terminal;

FIG. 11 is a view showing an example of a screen layout of an assignment checking screen displayed in the liquid crystal display of the player terminal; and

FIG. 12 is a view showing an example of a screen layout of a standby screen displayed in the liquid crystal display of the player terminal.

### DETAILED DESCRIPTION OF THE INVENTION

A gaming machine according to the invention will specifically be described below with reference to accompanying drawings. An embodiment embodying the invention by a card game will be described below, but the invention is not limited thereto, and applicable to games such as a roulette game and the like other than the card game.

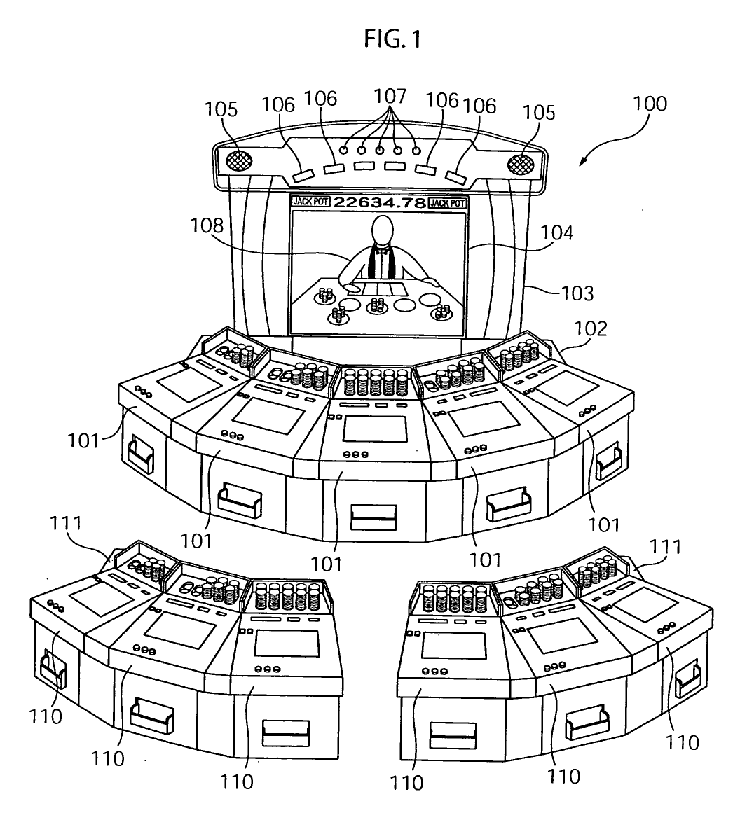

FIG. 1 is an external view of the gaming machine according to one embodiment of the invention. As shown in the figure, the gaming machine 100 has a first table portion 102 such that player terminals 101 called satellites are arranged in sector-shape, a panel portion 103 disposed forward of the table portion 102, and a second table portion 111 which is disposed rearward of the first table portion 102 and has sub-player terminals 110 installed therein. In an example as shown in the figure, five player terminals 101 are disposed in sector-shape toward the panel portion 103. Further, three sub-player terminals 110 are disposed toward the panel portion 103 in each of two regions, at the left side and right side, rearward of the player terminals 101.

The panel portion 103 is provided with a front display 104 that is a display device such as a liquid crystal display device, speaker 105, lamps 106 and LEDs 107. The front display 104 notifies each player of common information on the entire game in which participate players operating respective player terminals 101. For example, using animation of a dealer 108, displayed are a notice of start or end of bet receiving time, notification of winning or losing of the game and the like.

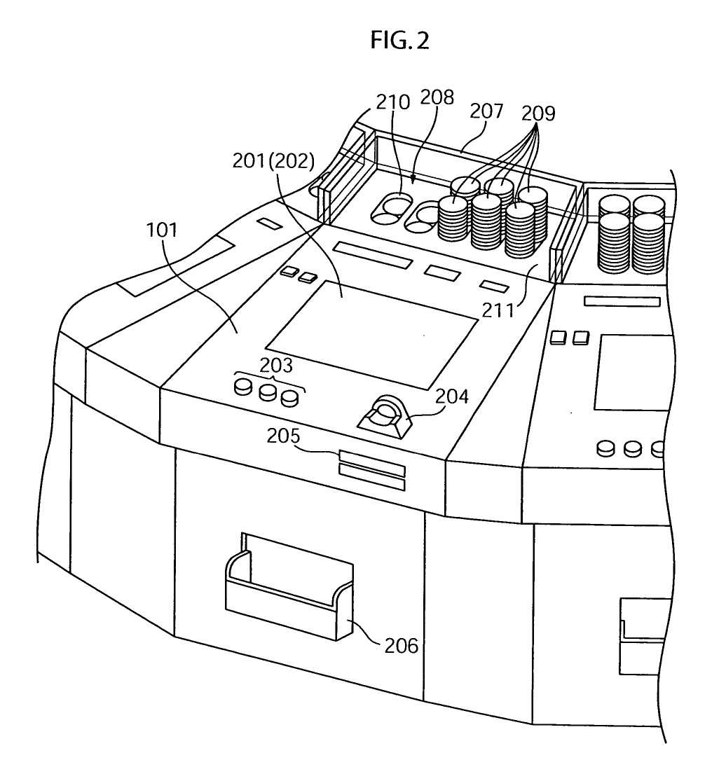

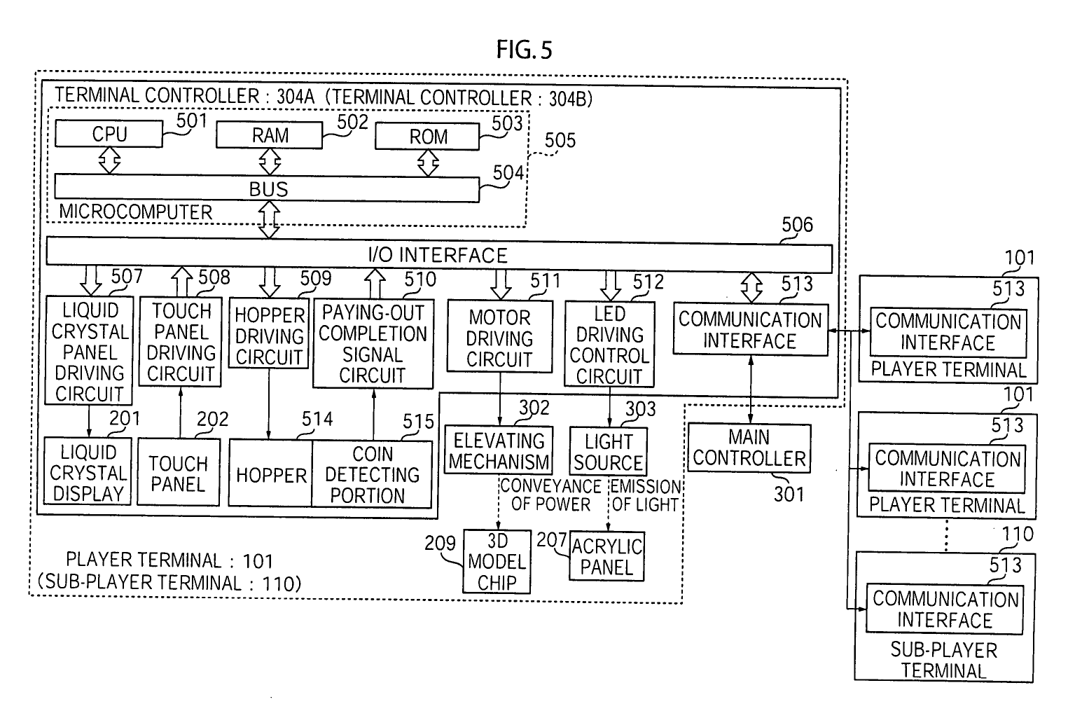

It is configured that a player operating the player terminal 101 disposed in the table portion 102 is able to participate in the game provided by the gaming machine 100. Meanwhile, it is configured that a player operating the sub-player terminal 110 disposed in the table portion 111 is able to participate in the game provided by the gaming machine 100 by acquiring a right (hereinafter, referred to as a “right to play” as appropriate) to play the game in a status of the game in the player of the player terminal 101. The sub-player terminal 110 has the same structure as that of the player terminal 101 except a respect that the sub-player terminal 110 is subject to the above-mentioned constrain in control to participate in the game. Therefore, explanations on an appearance (FIG. 2) and structure (FIG. 5) of the player terminal 101 described below are applicable to the sub-player terminal 110.

FIG. 2 is an enlarged view of the player terminal 101. The player terminal 101 has on its upper face a liquid crystal display 201 to provide the information of the game to a player. The liquid crystal display 201 is covered with a transparent touch panel 202. On the front side of the liquid crystal display 201 are arranged a group of a plurality of buttons 203 such as a PAYOUT button, BET button and the like for the player to use. To the right of the group of buttons 203 is provided a coin inserting portion 204 for the player to insert a game value medium (hereinafter, simply referred to as a “coin”) such as a coin, medal, chip and the like. The coin inserting portion 204 is provided with a coin sensor (not shown) that detects an inserted coin. On the lower side of the coin inserting portion 204 is provided a bill inserting portion 205 for the player to insert a bill. The bill inserting portion 205 is provided with a bill sensor (not shown) that detects an inserted bill.

A coin paying outlet 206 is provided in a front lower portion of the player terminal 101. In the player terminal 101, it is configured that corresponding to the operation of a player pressing the PAYOUT button contained in the group of buttons 203, the coin paying outlet 206 ejects a number of coins in response to all or part of a credit value possessed by the player stored in the terminal.

A U-shaped transparent acrylic panel 207 is provided forward (on the panel portion 103 side) of the liquid crystal display 201. A three-dimensional (3D) model chip exhibiting portion 208 is provided in a region surrounded by the transparent acrylic panel 207. The 3D model chip exhibiting portion 208 is comprised of 3D model chips 209, an exhibiting-portion plate 211 provided with openings 210 through which the 3D model chips 209 protrude outward from the inside of the player terminal 101, or which store protruding 3D model chips 209 inside the player terminal 101, and an elevating mechanism (not shown) that moves the 3D model chips 209 up and down.

Each of the 3D model chips 209 is a model of a pile of chips, and manufactured by forming a resin and the like. The 3D model chip exhibiting portion 208 has a plurality of 3D model chips 209 with different units. For example, prepared are 3D model chips representing a pile of chips each representing one credit, a pile of chips each representing ten credits, and a pile of chips each representing hundred credits. All the players are able to recognize a credit value possessed by the player promptly through intuition by seeing a height such that the 3D model chip 209 protrudes from the exhibiting-portion plate 211, while being given the realism as if the chips are increased or decreased actually in front of the player.

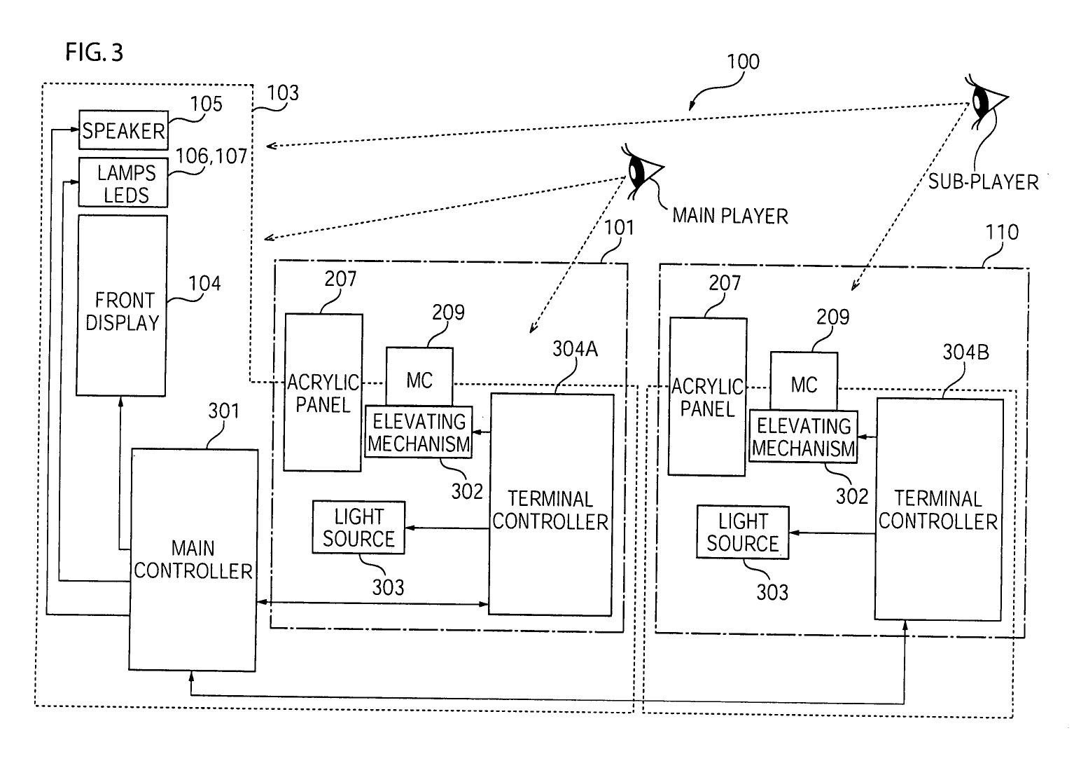

FIG. 3 is a schematic block diagram of an internal structure of the gaming machine 100 according to this embodiment. As shown in figure, the gaming machine 100 stores a main controller 301. The main controller 301 is comprised of an information processing apparatus and peripheral apparatuses that execute a game program, and is connected to each of the player terminals 101 and each of the sub-player terminals 110 enabling bidirectional communications. The main controller 301 receives notification of the number of bets and the like from each player terminal 101 and each sub-player terminal 110, and starts executing the game when a predetermined condition is met. Then, the main controller 301 determines wining or losing of the game, and notifies the result to each player terminal 101 (each sub-player terminal 110). Further, the main controller 301 performs control of output of image signals to be displayed in the front display 104, control of driving the lamps 106 and LEDs 107, and control of driving the speaker 105.

According to notification from the main controller 301, each player terminal 101 (each sub-player terminal 110) increases or decreases the credit value possessed by the player. For example, when the player wins the game, the player terminal 101 adds a credit value corresponding to the acquired number of coins to the already possessed credit value according to the notification from the main controller 301 to store again. Meanwhile, when the player loses the game, the player terminal 101 subtracts a credit value corresponding to the bet number of coins from the already possessed credit value according to the notification from the main controller 301 to store again.

The player terminal 101 (each sub-player terminal 110) is connected to a terminal controller 304A (terminal controller 304B) comprised of an information processing apparatus and peripheral apparatuses, and to an elevating mechanism 302 and a light source 303 both connected to the terminal controller 304A (304B). The elevating mechanism 302 is means for moving the 3D model chip 209 up and down, and in this embodiment, is provided with a stepping motor as elevating power. In addition, the elevating power is not limited thereto, and may include a typical motor combined with a position control mechanism. The light source 303 is comprised of a circuit having emission sources such as a plurality of LEDs, and functions as a light source capable of varying different colors (for example, red, blue, green, white and the like) and the brightness. The light emitted from the light source 303 is guided by the acrylic panel 207, and output to the outside of the gaming machine 100, particularly, in the direction enabling the light to be visually identified by the player.

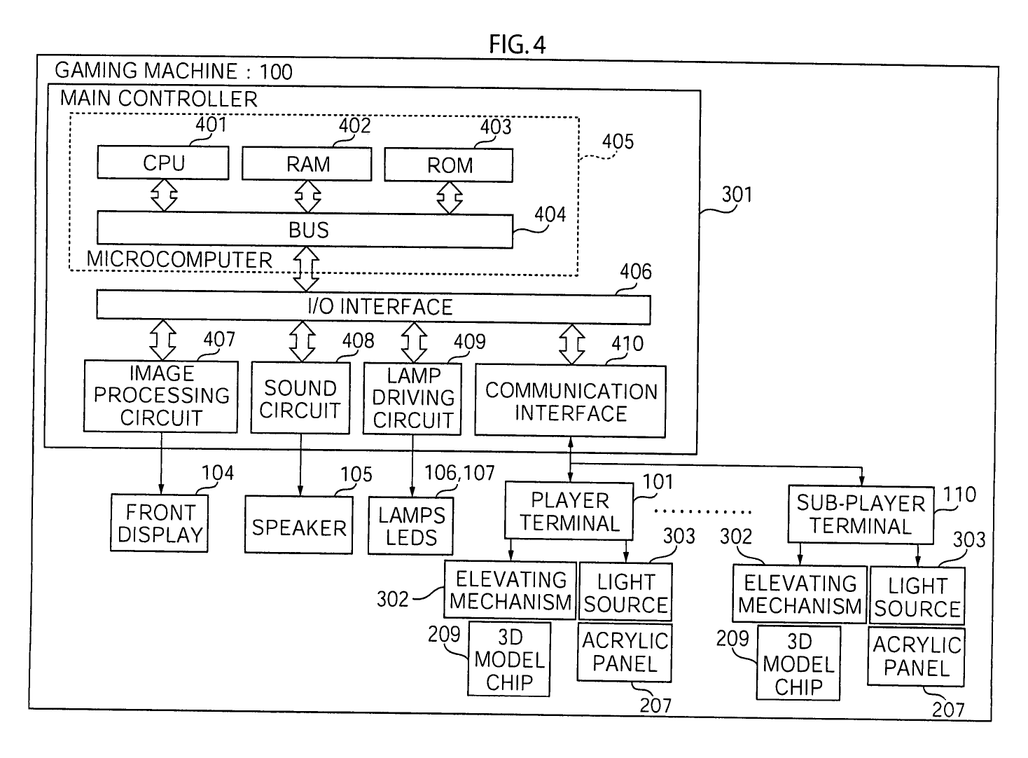

An example of a configuration of the main controller 301 will be described below with reference to FIG. 4. FIG. 4 is a block diagram of the gaming machine 100 mainly showing the main controller 301.

The main controller 301 is basically configured of a microcomputer 405 as a core comprised of a CPU 401, RAM 402, ROM 403 and bus 404 for data transfer among the CPU 401, RAM 402 and ROM 403. The CPU 401 is connected to the ROM 403 and RAM 402 through the bus 404. The ROM 403 stores various programs, data tables and the like to perform processing required to control the gaming machine 100. The RAM 402 is memory to temporarily store various data computed in the CPU 401.

The microcomputer 405 (more specifically, the CPU 401) is connected to an image processing circuit 407 via an I/O interface 406. The image processing circuit 407 is connected to the front display 104 to control driving of the front display.

The image processing circuit 407 is comprised of a program ROM, image ROM, image control CPU, work RAM, VDP (Video Display Processor), video RAM and the like. The program ROM stores a program for image control and various selection tables for display in the front display 104. The image ROM stores dot data to form images, for example, dot data to form images in the front display 104. The image control CPU determines an image to be displayed in the front display 104 from the dot data beforehand stored in the image ROM according to the image control program beforehand stored in the program ROM, based on parameters set by the CPU 401. The work RAM is configured as temporary storing means when the image control program is executed in the image control CPU. The VDP generates image data corresponding to the content of display determined in the image control CPU to output to the front display 104. In addition, the video RAM is configured as temporary storing means when the VDP forms the image.

The microcomputer 405 (more specifically, CPU 401) is connected to the speaker 105 via a sound circuit 408. The speaker 105 generates various sound effects, BGM and the like based on output signals from the sound circuit 408 in performing various kinds of representation.

The microcomputer 405 (more specifically, CPU 401) is further connected to the lamps 106 and LEDs 107 via a lamp driving circuit 409. Pluralities of the lamps 106 and LEDs 107 are disposed on the front face of the gaming machine 100 and controlled to be lighted by the lamp driving circuit 409 based on driving signals from the CPU 401 in performing various kinds of representation.

The microcomputer 405 (more specifically, CPU 401) is further connected to each player terminal 101 via a communication interface 410, and thereby enables bidirectional communications between the CPU 401 and player terminal 101. The CPU 401 is able to transmit and receive a command, request and the like to/from each player terminal 101, and the main controller 301 and player terminal 101 cooperate to control proceeding of a game.

An example of a configuration of the player terminal 101 will specifically be described below. FIG. 5 is a functional block diagram illustrating a control system of the player terminal 101.

The player terminal 101 is basically configured of a microcomputer 505 as a core comprised of a CPU 501, RAM 502, ROM 503 and bus 504 for data transfer among the CPU 501, RAM 502 and ROM 503. The CPU 501 is connected to the ROM 503 and RAM 502 through the bus 504. The ROM 503 stores various programs, data tables and the like to perform processing required to control the player terminal 101, such as operation control of the elevating mechanism 302, on/off control of the light source 303 and the like. The RAM 502 is memory to temporarily store various data computed in the CPU 501.

The microcomputer 505 (more specifically, CPU 501) is connected to a liquid crystal panel driving circuit 507 via an I/O interface 506. The liquid crystal panel driving circuit 507 is connected to the liquid crystal display 201, and controls driving of the liquid crystal display 201.

The microcomputer 505 (more specifically, CPU 501) is further connected to a touch panel driving circuit 508 via the I/O interface 506. The touch panel driving circuit 508 outputs coordinate data of a touch position on the touch panel 202.

The microcomputer 505 (more specifically, CPU 501) is further connected to a hopper 514 via a hopper driving circuit 509. When the CPU 501 outputs a driving signal to the hopper driving circuit 509, the hopper 514 pays a predetermined number of coins out of the coin paying outlet 206. The CPU 501 is further connected to a coin detecting portion 515 via a paying-out completion signal circuit 510. The coin detecting portion 515 is disposed inside the coin paying outlet 206. When detecting that a predetermined number of coins are paid out of the coin paying outlet 206, the coin detecting portion 515 outputs a coin paying-out detection signal to the paying-out completion signal circuit 510. Based on the signal, the paying-out completion signal circuit 510 outputs a paying-out completion signal to the CPU 501.

The microcomputer 505 (more specifically, CPU 501) is further connected to a motor driving circuit 511 that rotary-drives the stepping motor to drive the elevating mechanism 302. When the CPU 501 outputs a motor driving signal to the motor driving circuit 511, the stepping motor is rotary-driven by the motor driving circuit 511. The elevating mechanism 302 is thereby activated and performs the operation for moving the 3D model chip 209 up and down.

The microcomputer 505 (more specifically, CPU 501) is further connected to an LED driving control circuit 512 to drive the light source 303. In this embodiment, the light source 303 is comprised of a plurality of LEDs, and corresponding to an LED driving command from the CPU 501, the LED driving control circuit 512 supplies driving power to LEDs targeted for the driving command among all the LEDs. By this means, it is possible to control the LEDs to be lighted on/off in a desired mode under control of the CPU 501. Particularly, in this embodiment, the light source 303 is comprised of five red LEDs, five blue LEDs, and five white LEDs. The LED driving control circuit 512 is formed of circuitry capable of selectively supplying power to light on and off the five red LEDs, five blue LEDs, and five white LEDs independently of one another.

The microcomputer 505 (more specifically, CPU 501) is further connected to the main controller 301 via a communication interface 513, and thereby enables bidirectional communications between the CPU 501 and main controller 301. The CPU 501 transmits and receives a command, request, data and the like to/from the main controller 301, and the main controller 301 and player terminal 101 are thereby capable of cooperating to control proceeding of a game.

The microcomputer 505 (more specifically, CPU 501) is further connected to the sub-player terminal 110 or another communication interface 513 of another player terminal 101 via the communication interface 513, and thereby enables bidirectional communications between the CPU 501 and the sub-player terminal 110 or another CPU 501 of another player terminal 101. The CPU 501 transmits and receives a command, request, data and the like to/from the sub-player terminal 110 or another CPU 501 of another player terminal 101, and the player terminal 101 and another player terminal 101 are thereby capable of cooperating to control proceeding of a game.

The gaming machine 100 according to this embodiment has the aforementioned configuration, and enables a right to play the game to be assigned between the player terminal 101 and the sub-player terminal 110 using coins. By thus enabling the right to play the game to be assigned between the player terminal 101 and the sub-player terminal 110, it is possible to improve the characteristic of pulling in customers of the game, while causing the game to proceed by a number of players suitable for acquisition of a sense of realism. In addition, as the case of assigning the right to play, for example, such a case is considered that when all the player terminals 101 are being used by players for the game, a player of the sub-player terminal 110 wants to play the game without waiting for finish of the game of the players currently participating in the game, and the like.

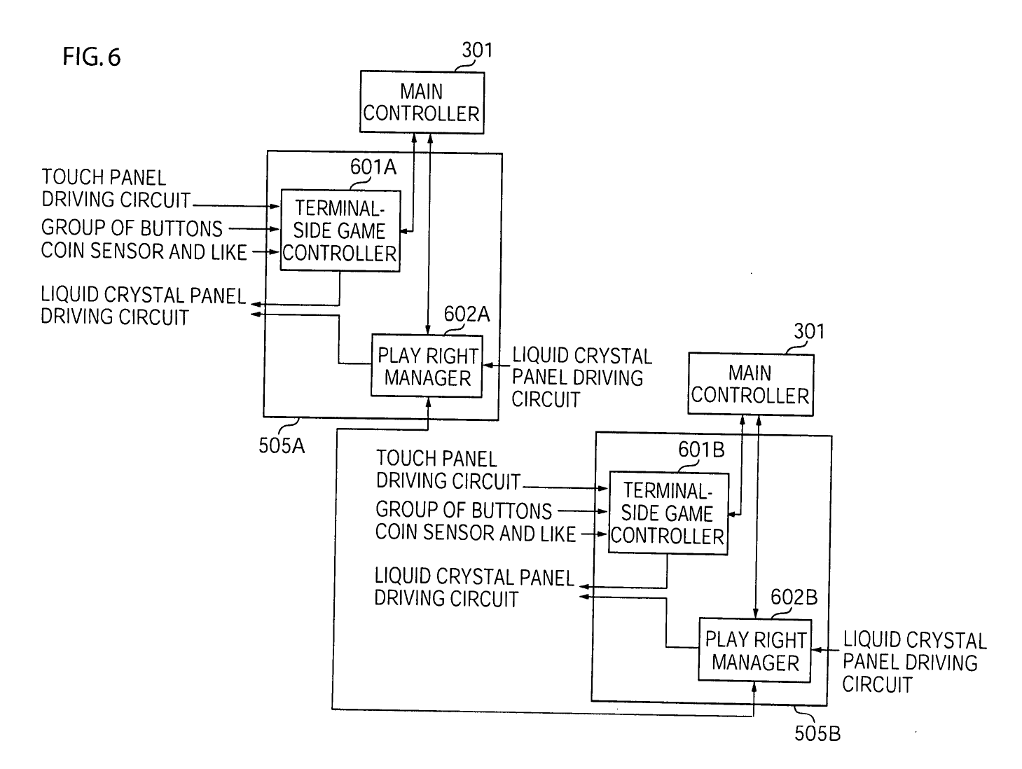

FIG. 6 is a block diagram to explain the function of the microcomputers 505 of the player terminal 101 and the sub-player terminal 110, while being a functional block diagram mainly related to processing of assigning the right to play. As shown in FIG. 6, the microcomputers 505 of the player terminal 101 and sub-player terminal 110 have the same functional block, while being different from each other in control corresponding to whether or not to have the right to play the game. Herein, the microcomputer 505 of the player terminal 101 is shown by “microcomputer 505A”, while the microcomputer 505 of the sub-player terminal 110 is shown by “microcomputer 505B”. Further, structural elements of the microcomputers 505A and 505B are given “A” or “B” at the last as appropriate to specify the elements, respectively.

As shown in the figure, each of the microcomputers 505A and 505B has a terminal-side game controller (hereinafter, simply referred to as a “game controller”) 601 constituting game control means by controlling proceeding of a game in the gaming machine 100 cooperating with the main controller 301, and a play right manager 602 corresponding to assignment managing means.

The game controller 601 performs control to conduct the game on the player terminal 101 (sub-player terminal 110) side. For example, the controller 601 receives inputs by a player on a designation of a bet amount, designation of strategy in response to a status of proceeding of the game and the like via the touch panel driving circuit 508, group of buttons 203 and the like, while notifying the main controller 301 of the received player's inputs. Further, the controller 601 displays a display image according to a result of wining/losing of the game notified from the main controller 301 in the liquid crystal display 201 via the liquid crystal panel driving circuit 507.

The play right manager 602 performs various kinds of control for performing the processing of assigning the right to play the game. More specifically, the manager 602 performs various kinds of control such as provision of various screens required to make assignment of the right to play with another play right manager 602 of the player terminal 101 (sub-player terminal 110) of an assignment processing destination (assignment source or assignment destination) of the right to play the game, reception of instructions of a player input from the screen, notification of the instructions to the main controller 301, and the like.

For example, the play right manager 602 provides a screen (hereinafter, referred to as an “assignment request receiving screen”) to receive a request for assignment of the right to play, or a screen (hereinafter, referred to as an “assignment checking screen”) to check whether the assignment of the right to play is permitted or rejected by the player. Further, the manager 602 transmits the request for assignment of the right to play to another play right manager 602 of an assignment source in response to instructions of the player received from the assignment request receiving screen, while further transmitting assignment permission notification or assignment rejection notification to another play right manager 602 of an assignment destination in response to instructions of the player received from the assignment checking screen. When the right to play is assigned, the manager 602 further transmits an assignment notification signal indicative of execution of the assignment to the game controller 601 and main controller 301.

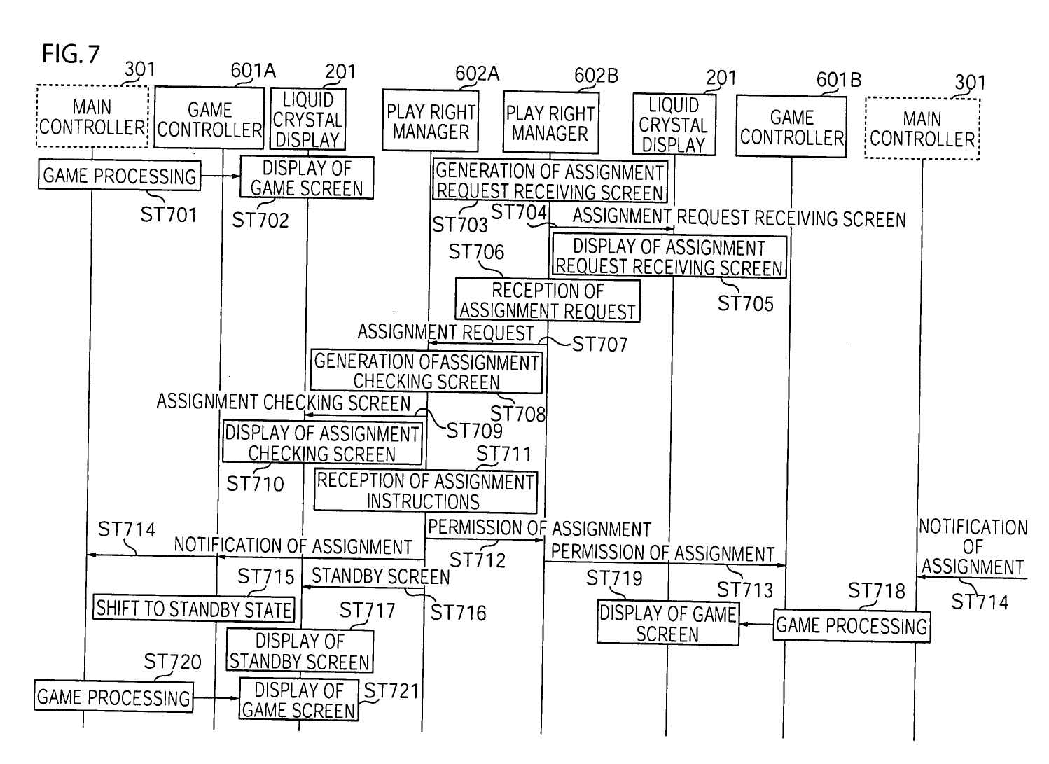

The processing in the gaming machine according to this embodiment will be described below when the right to play is assigned. FIG. 7 is a sequence diagram to explain the processing when the right to play is assigned between the player terminal 101 and the sub-player terminal 110 in the gaming machine 100 according to this embodiment.

In FIG. 7, a case is explained that the sub-player terminal 110 purchases the right to play from the player terminal 101 in the middle of a period during which the player terminal 101 as shown in FIG. 6 is playing the game ordinarily. Further, in the FIG. 7, the case is explained that as the content of the card game, “blackjack” is carried out using a pack of cards. In addition, the content of the card game is not limited to blackjack.

In the sequence as shown in FIG. 7, for convenience in description, it is assumed that the assignment of the right to play is made using a predetermined number of (for example, fifty) coins. As a condition in assigning the right to play, however, modifications can be made as appropriate, and as described below, the number of coins for the assignment may be negotiated between players respectively operating the player terminal 101 and sub-player terminal 110. Further, in the sequence as shown in FIG. 7, for convenience in description, a target for the assignment of the right to play is a single base game (a series of games until wining or losing is determined by distributed cards). As a target for the assignment of the right to play, however, modifications can be made as appropriate, and as described below, the target may include a split game, double-down game and the like that are part of the game performed during the base game.

As shown in FIG. 7, when a base game is carried out, in the player terminal 101A, the game controller 601A performs game processing for generating screen data of the game screen and outputting the screen data to the liquid crystal display 201 via the liquid crystal panel driving circuit 507, while receiving information (hereinafter, referred to as “game screen information”) required to display the game screen including the card data from the main controller 301 (ST701). The liquid crystal display 201 receives the screen data output from the game controller 601A by the game processing to display the game screen (ST702).

At this point, in the sub-player terminal 110, the play right manager 602B generates screen data of the assignment request receiving screen (ST703), and outputs the screen data to the liquid crystal display 201 (ST704), while receiving information required to display the assignment request receiving screen including the card data from the main controller 301. The liquid crystal display 201 receives the screen data output from the play right manager 602B, and displays the assignment request receiving screen (ST705).

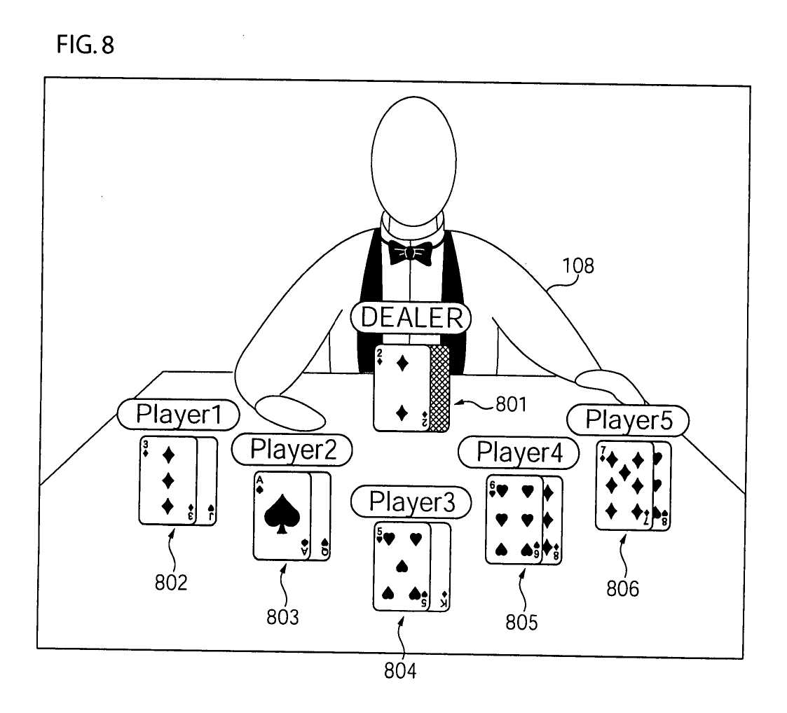

Referring to FIGS. 8 to 10, described herein are examples of screen layouts displayed in the gaming machine 100, player terminal 101 and sub-player terminal 110 when the above-mentioned game processing is carried out. FIGS. 8, 9, and 10 are views showing examples of screen layouts displayed in the front display 104 of the gaming machine 100, liquid crystal display 201 of the player terminal 101, and liquid crystal display 201 of the sub-player terminal 110, respectively. In addition, FIGS. 8 to 10 show a status after cards are distributed to each player.

As shown in FIG. 8, the front display 104 of the gaming machine 100 displays image data of the dealer 108, while displaying cards 801 (hereinafter, referred to as “dealer cards”) distributed to the dealer and cards (hereinafter, referred to as “player cards”) 802 to 806 distributed to players. The dealer cards 801 are displayed in the front of the dealer 108, and player cards 802 to 806 are displayed in respective positions corresponding to installation positions of player terminals 101. The cards are updated as appropriate corresponding to a status of proceeding of the game. Such a screen is displayed in the front display 104, and each player (including players of sub-player terminals 110) is thereby able to check what cards are distributed to each player.

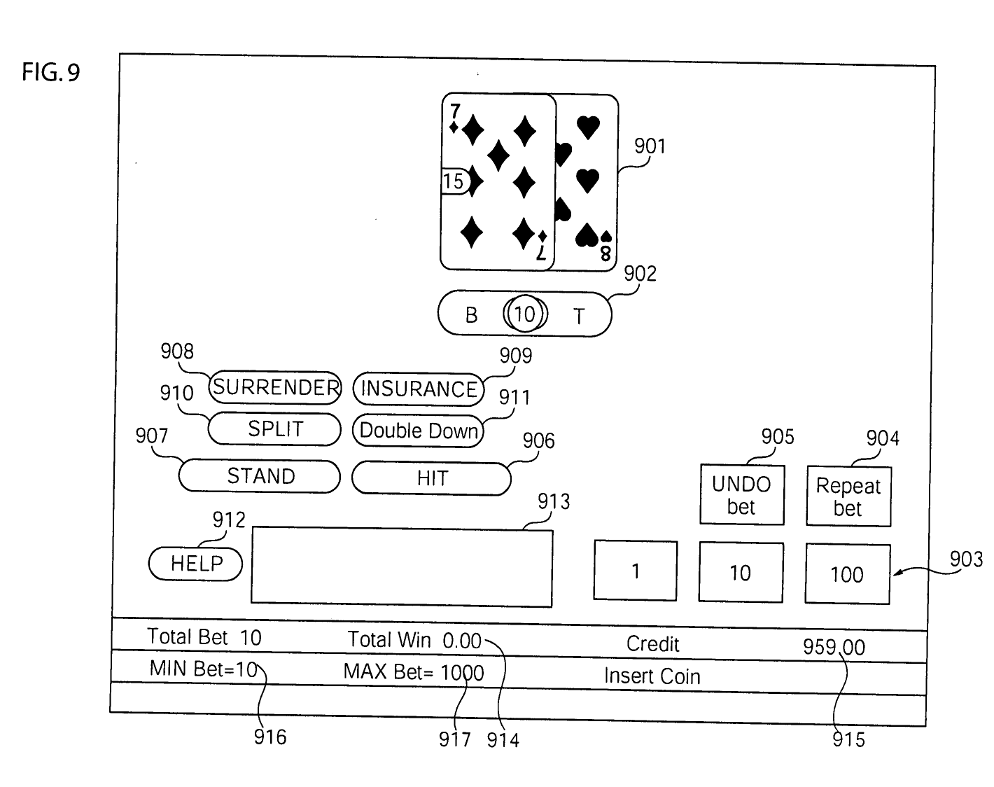

Meanwhile, as shown in FIG. 9, the liquid crystal display 201 of the player terminal 101 displays player cards 901 in a position on the front side (on the panel portion 103 side) in the liquid crystal display 201. Then, a chip display area 902 is provided under the player cards 901. In the chip display area 902 is displayed an image of chips corresponding to a number of coins bet by the player, thereby performing representation to add a sense of realism. In addition, FIG. 9 shows a case of displaying an image of chips corresponding to ten coins.

A plurality of bet buttons 903 is displayed to the right lower side of the chip display area 902. A player touches the bet button 903 as appropriate, and is thereby capable of inputting a desired bet value. In addition, in the example as shown in the figure, values of “1”, “10”, and “100” are respectively set on the bet buttons 903, and the number of coins corresponding to a value set by one touch is added to the bet value.

Above the bet buttons 903 are displayed a Repeat bet button 904 and UNDO bet button 905. The player is capable of betting the number of coins bet in the last participating game by touching the Repeat bet button 904. Meanwhile, the player is capable of canceling the number of last bet coins by touching the UNDO bet button 905.

To the left lower side of the chip display area 902 are displayed a group of operation buttons used by the player in bargaining with the dealer. More specifically, displayed as the operation buttons are a HIT button 906, STAND button 907, SURRENDER button 908, INSURANCE button 909, SPLIT button 910, and DoubleDown button 911.

The HIT button 906 is an operation button to be touched by a player in requesting distribution of another card to add to distributed cards. The HIT button 906 is allowed to be used continuously until the total number of distributed cards becomes twenty-one or more. The STAND button 907 is an operation button to be touched in playing a hand using currently distributed cards without requesting distribution of another card.

The SURRENDER button 908 is an operation button to be touched in surrendering the current game. When the SURRENDER button 908 is selected, a half of the bet value at this point is paid to the dealer, while the left half is returned to the player. The INSURANCE button 909 is an operation button to be touched in insuring against blackjack of the dealer cards 801 with a half of the bet value at this point. In addition, the SURRENDER button 908 is usable except an up-card (viewable card) of the dealer being “A” (ace), and the INSURANCE button 909 is usable when the up-card is “A” (ace).

The SPLIT button 910 is an operation button to be touched in the case of splitting two cards into two sets when the two cards distributed in the game have the same number. When the SPLIT button 910 is selected, the player is capable of playing a hand with each of two sets. In addition, after splitting the cards into two sets, when a card with the same number is distributed again, the cards can be split again. The split is permitted up to maximum three times in one game. The DoubleDown button 911 is an operation button to be touched in doubling the bet value in the game. After selecting the DoubleDown button 911, it is made a condition that only one card is drawn without drawing more cards.

Under the HIT button 906 and STAND button 907, a HELP button 912 is displayed, while a message area 913 is provided. The HELP button 912 is a button to be touched in requesting an explanation of the game (herein, blackjack). In the message area 913 is displayed a message to support proceeding of the game according to a current state of the game. For example, a message such as “please bet” and the like is displayed at the bet receiving time. The message area 913 also displays a message to explain the game when the HELP button 912 is selected.

In the lowest region of the liquid crystal display 201 are provided an area (gained credit value displaying area) 914 to display a credit value gained by the player, and an area (possessed credit value displaying area) 915 to display the credit value possessed by the player. Provided further are an area (bet value lower limit displaying area) 916 to display a lower limit of the bet value, and an area (bet value upper limit displaying area) 917 to display an upper limit of the bet value. By displaying the lower limit and upper limit of the vet value, the player is encouraged to determine a bet value in a range indicated by the limits.

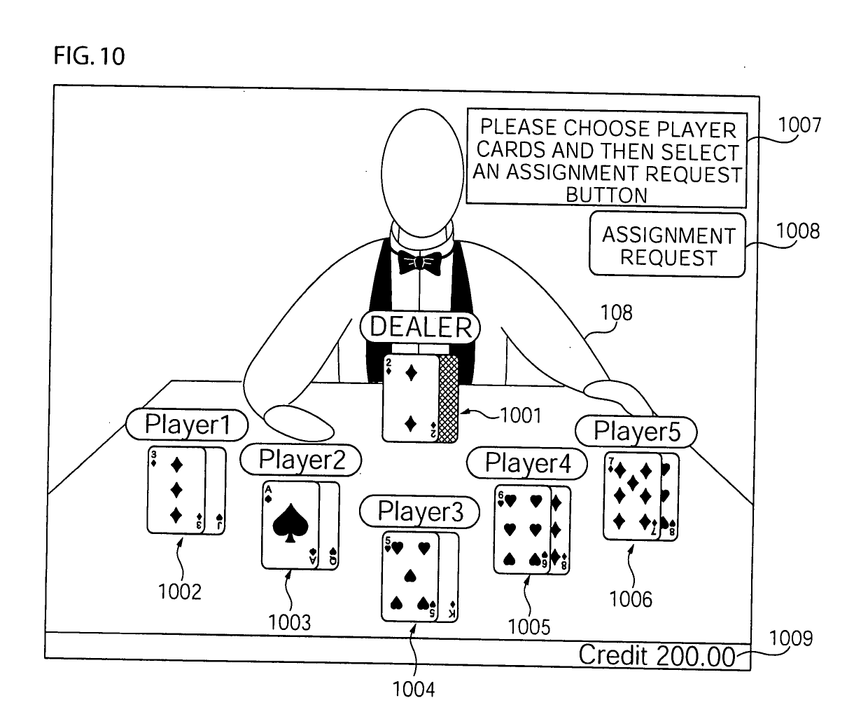

As shown in FIG. 10, in the liquid crystal display 201 of the sub-player terminal 110 is displayed a screen similar to the screen displayed in the front display 104 of the gaming machine 100. In other words, the image data of the dealer 108 is displayed, while dealer cards 1001, and player cards 1002 to 1006 are further displayed. Each card displayed in the liquid crystal display 201 is also updated as appropriate in the same way as in each card displayed in the front display 104.

In addition, the screen displayed in the liquid crystal display 201 of the sub-player terminal 110 differs from the screen displayed in the front display 104 of the gaming machine 100 in that a message area 1007 is provided while an assignment request button 1008 is displayed to the right upper side of the image data of the dealer 108, and that a possessed credit value displaying area 1009 is provided in the lowest region of the liquid crystal display 201.

In the message area 1007 is displayed a message to support proceeding of the game according to a current state of the game. For example, at the bet receiving time enabling a request for assignment of the right to play the game, as shown in FIG. 10, such a message is displayed that “Please choose player cards and then select an assignment request button”. Further, the assignment request button 1008 is a button to be touched in choosing player cards and then requesting assignment of the right to play to a corresponding player. A player of the sub-player terminal 110 chooses either of player cards and then touches the assignment request button 1008, and an assignment request signal described later is thereby transmitted to the player terminal 101 corresponding to the chosen player cards.

Referring to FIG. 7 again, described further is the processing for assigning the right to play in the gaming machine 100 in this embodiment. In the middle of a period during which the player terminal 101 executes the game processing, when a player of the sub-player terminal 110 chooses player cards from the assignment request receiving screen as shown in FIG. 10 and then selects the assignment request button 1008, the play right manager 602B receives an assignment request for the right to play (ST706), and outputs an assignment request signal to the play right manager 602A of the player terminal 101 (ST707).

Upon receiving the assignment request signal, the play right manager 602A generates screen data (ST708) of the assignment checking screen based on the information (for example, identification information of the sub-player terminal 110) included in the signal, and outputs the screen data to the liquid crystal display 201 (ST709). The liquid crystal display 201 receives the screen data output from the play right manager 602A, and displays the assignment checking screen (ST710).

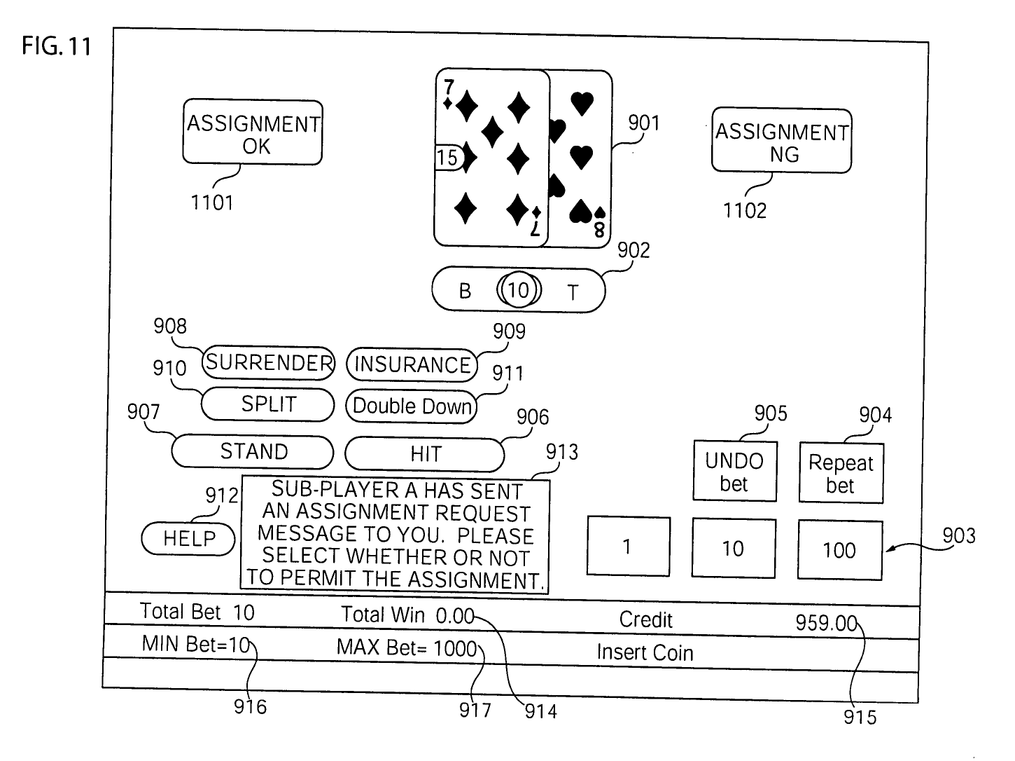

FIG. 11 is a view showing an example of a screen layout of the assignment checking screen displayed in the liquid crystal display 201 of the player terminal 101 that receives the assignment request. As shown in FIG. 11, the assignment checking screen has a screen layout obtained by adding operation buttons required to check the assignment to the display screen as shown in FIG. 9. In other words, on the assignment checking screen, to the left of the player cards 901 is displayed an assignment permission button 1101 to be touched in the case of permitting the assignment of the right to play, while to the right of the player cards 901 is displayed an assignment rejection button 1102 to be touched in the case of not permitting the assignment of the right to play. In addition, on the assignment checking screen, the message area 913 displays a message indicating that an assignment request is made. For example, as shown in FIG. 11, such a message is displayed that “Sub-player A has sent an assignment request message to you. Please select whether or not to permit the assignment.”

When the player selects the assignment checking button (assignment permission button 1101 or assignment rejection button 1102) from the assignment checking screen as shown in FIG. 11, the play right manager 602A receives an assignment instruction of the right to play (ST711), and transmits an assignment instruction signal (assignment permission signal or assignment rejection signal) corresponding to the assignment instruction to the play right manager 602B of the sub-player terminal 110 (ST712). It is herein assumed that the player selects the assignment permission button 1101 as the assignment checking button, and corresponding to the permission, the assignment permission signal is transmitted to the play right manager 602B.

Upon receiving the assignment permission signal, the play right manager 602B transfers the assignment permission signal to the game controller 601B (ST713). Upon receiving the assignment permission signal, the game controller 601B prepares for the game processing to be started together with the main controller 301 after the right to play is assigned.

Meanwhile, when the assignment permission button 1101 is selected from the assignment checking screen, the play right manager 602A transmits an assignment notification signal indicative of assigning the right to play the current game to the game controller 601A and main controller 301 (ST714). In addition, the assignment notification signal includes information to identify the sub-player terminal 110 that acquires assignment of the right to play.

Upon receiving the assignment notification signal, the game controller 601A recognizes that the right to play is temporarily transferred to the sub-player terminal 101 that has made an assignment request, and shifts to a standby state for waiting for resume of the game processing (ST715). At the timing when the game controller 601A shifts to the standby state, the play right manager 602A generates screen data of a standby screen including a standby message, and outputs the screen data to the liquid crystal display 201 (ST716). The liquid crystal display 201 displays the standby screen output from the play right manager 602A (ST717).

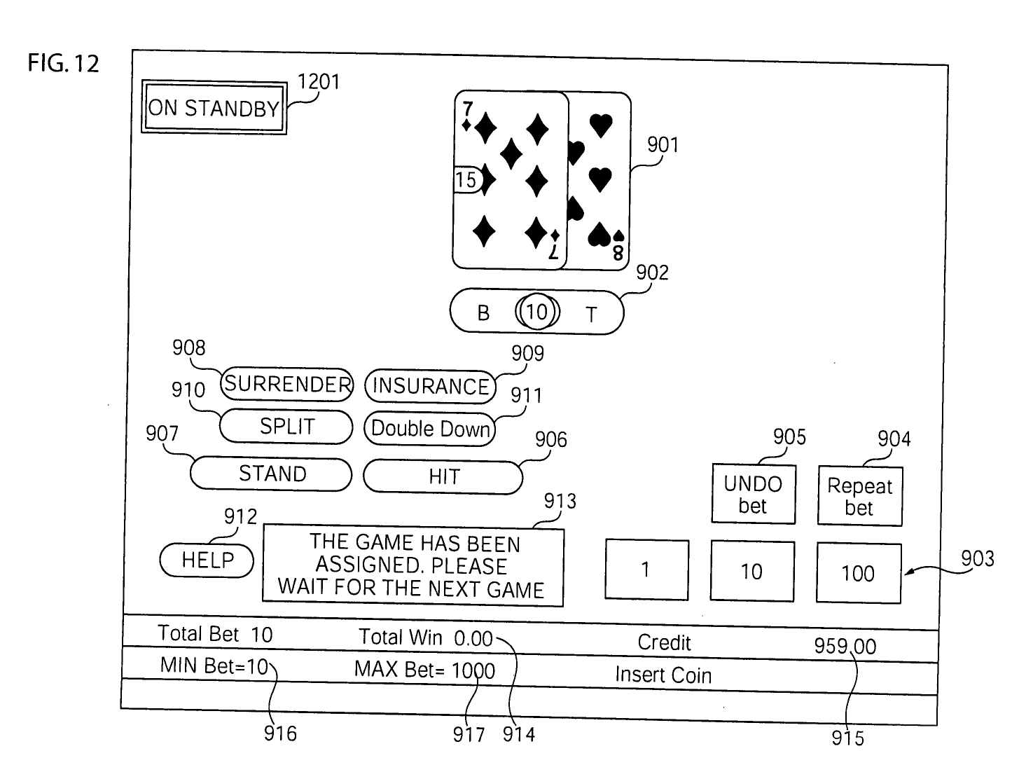

FIG. 12 is a view showing an example of a screen layout of the standby screen displayed in the liquid crystal display 201 of the player terminal 101 after assigning the right to play. As shown in FIG. 12, on the standby screen, to the left of the player cards 901 is displayed a standby button 1201 enabling “on standby” to be easily recognizable, while in the message area 913 is displayed a message indicating that the right to play has been assigned and that the terminal is waiting for the next game. For example, as shown in FIG. 12, such a message is displayed that “The game has been assigned. Please wait for the next game.”

Meanwhile, upon receiving the assignment notification signal transmitted from the play right manager 602A in ST714, the main controller 301 transmits the game screen information including the card data to the game controller 601B of the corresponding sub-player terminal 110 according to the identification information of the sub-player terminal 110 as an assignment destination included in the assignment notification signal.

The game controller 601B of the sub-player terminal 110 performs the game processing for generating screen data to display in the liquid crystal display 201 and outputting the screen data to the liquid crystal display 201 via the liquid crystal panel driving circuit 507, while receiving the information transmitted from the main controller 301 (ST718). The liquid crystal display 201 receives the screen data output from the game controller 601B by the game processing, and displays the game screen (ST719). By this means, the player of the sub-player terminal 110 is capable of enjoying the assigned game.

Then, when the game of which the right to play has been assigned is finished, the main controller 301 returns the right to play to the player terminal 101 that has assigned the right to play. The main controller 301 transmits the game screen information including the card data to the game controller 601A of the player terminal 101. Upon receiving the information, the game controller 601A resumes the game processing (ST720). The liquid crystal display 201 also receives the screen data output from the game controller 601A by the game processing, and displays again the game screen (ST721).

In addition, not shown in FIG. 7, when the assignment rejection button 1102 is selected from the assignment checking screen, the play right manager 602A only transmits the assignment rejection signal to the play right manager 602B, and does not transmit any signals to the game controller 601 and main controller 301. Therefore, the player terminal 101 continues the game processing.

Thus, in the gaming machine 100 according to this embodiment, the play right manager 602 manages assignment of the right to play in a status of the game of the player playing the game, while prepared are sub-player terminals 110 operable by persons who desire to participate in the game, and it is thereby possible to provide an occasion to play to the game participation desirer. Therefore, it is made possible to improve the characteristic of pulling in customers of the game, while causing the game to proceed by a number of players suitable for acquisition of a sense of realism.

Further, in the gaming machine 100 according to this embodiment, the play right manager 602 generates the assignment request receiving screen as shown in FIG. 10 or the assignment checking screen as shown in FIG. 11 to be displayed in the liquid crystal display 201, and a participation desirer or a player is thereby capable of inputting his/her intention via the screen, and thus, of making assignment of the right to play the game with simple operation on the screen.

In addition, the explanation in the foregoing shows the case that a player of the sub-player terminal 110 acquires a right to play from a player of the player terminal 101. However, a player to acquire the right to play is not limited to a player of the sub-player terminal 110, and a player of the player terminal 101 may acquire the right to play from a player of another player terminal 101. In this case, for example, it is possible to cope with a case that a player of some player terminal 101 wants to play the game with cards distributed to a player of another player terminal 101 instead of cards distributed in the some player terminal 101.

Further, the explanation in the foregoing shows the case that assignment of the right to play is made with a predetermined certain number of coins, but the condition in assigning the right to play can be modified as appropriate. For example, the number of coins for assignment of the right to play may be negotiated between players respectively operating the player terminal 101 and sub-player terminal 110. It is considered in this case that an input area enabling an input of the acceptable number of coins to pay for the right to play is provided on the assignment request receiving screen displayed in the sub-player terminal 110 to include the information in the assignment request signal, while the designated number of coins is displayed on the assignment checking screen displayed in the player terminal 101. Further, an input area enabling an input of the acceptable number of coins to assign the right to play may be provided on the assignment checking receiving screen, while the information of the number of coins is returned to the sub-player terminal 110 to cause the players to determine the appropriate number of coins for the assignment of the right to play. In this case, the players are allowed to negotiate the number of coins appropriate to assign the right to play, and it is thereby possible to perform the processing for assigning the right to play more smoothly.

Furthermore, the explanation in the foregoing shows the case that a target for assignment of the right to play is one base game, but the target for assignment of the right to play can be modified as appropriate. For example, the target for assignment of the right to play may include a split game, double-down game and the like that are part of the game performed during the base game. It is considered in this case that a purchase target designating button to enable designation of a target for purchase of the right to play is provided on the assignment request receiving screen displayed in the sub-player terminal 110 to include the information in the assignment request signal, while the designated target for purchase is displayed on the assignment checking screen displayed in the player terminal 101. When thus modification is made, it is possible to assign various kinds of games during a single game, and therefore, to make assignment of the right to play with variations.

The present invention is not limited to the above described embodiment, and various variations and modifications may be possible without departing from the scope of the present invention. In the aforementioned embodiment, sizes and shapes shown in the accompanying drawings are not limited thereto, and capable of being modified as appropriate within the scope of exhibiting the effects of the invention. Further, the invention is capable of being carried into practice with various modifications thereof as appropriate without departing from the scope of the object of the invention.

The above-mentioned embodiment describes the case that the main controller 301 intervenes in transferring the right to play the game. However, the control in transferring the right to play can be modified as appropriate, and the player terminal 101 and sub-player terminal 110 may directly perform the control without the main controller 303 intervening.

Further, the above-mentioned embodiment describes the case of using coins that are of an example of play value media in assigning the right to play. However, a game value medium in assigning the right to play is not limited thereto, and may adopt any forms that would be game value media to play in the gaming machine 100. For example, a credit value obtained by inserting a coin, or credit value acquired by the game may be used as a game value medium in assigning the right to play.

This application is based on the Japanese Patent Application No.2005-270855 filed on Sep. 16, 2005, the entire content of which is expressly incorporated by reference herein.

1. A gaming machine that provides a series of games using a plurality of player terminals each displaying a status of a game of respective one of players, and a common display portion displaying statuses of the game of all the players, comprising:
a game controller that performs control to conduct the game; and
an assignment manager that manages assignment of a right to play in the status of the game of a player playing the game.

2. The gaming machine according to claim 1, wherein the assignment manager displays in the player terminal an assignment request receiving screen to receive an assignment request for the right to play in the status of the game of the player playing the game.

3. The gaming machine according to claim 2, wherein upon receiving the assignment request from the assignment request receiving screen, the assignment manager outputs a signal for requesting the assignment to the player terminal as an assignment source.

4. The gaming machine according to claim 3, wherein the player terminal has a touch panel capable of receiving operation from the player, and receives the assignment request from the touch panel.

5. The gaming machine according to claim 1, wherein the assignment manager displays in the player terminal an assignment permission/rejection receiving screen that receives permission or rejection of the assignment of the right to play in the status of the player playing the game.

6. The gaming machine according to claim 5, wherein upon receiving permission or rejection of the assignment of the right from the assignment permission/rejection receiving screen, the assignment manager outputs a signal for permitting or rejecting the assignment to another player terminal as an assignment destination.

7. The gaming machine according to claim 6, wherein the player terminal has a touch panel capable of receiving operation from the player, and receives permission or rejection of the assignment of the right from the touch panel.

8. The gaming machine according to claim 1, wherein after assigning the right to play in the status of the player playing the game, the assignment manager displays in the player terminal a standby screen to notify the player of a standby state.

9. The gaming machine according to claim 1, wherein the plurality of player terminals includes a sub-player terminal operated by a person who desires to participate in the game but is not able to participate in the game.

10. The gaming machine according to claim 1, wherein the assignment manager manages assignment of a right to play in part of the game included in the game.
